(19) United States
(12) Patent Application Publication
(10) Pub. No.: US 2024/0295463 A1
(43) Pub. Date: Sep. 5, 2024

(54) DEVICE FOR IMAGING THROUGH AN OPTICAL SYSTEM TO BE TESTED, AND SYSTEM AND METHOD FOR TESTING AN OPTICAL SYSTEM

(71) Applicant: TRIOPTICS GmbH, Wedel (DE)

(72) Inventors: Aiko RUPRECHT, Wedel (DE); Stefan KREY, Wedel (DE)

(73) Assignee: TRIOPTICS GmbH, Wedel (DE)

(21) Appl. No.: 18/574,517

(22) PCT Filed: Jun. 23, 2022
(86) PCT No.: PCT/EP2022/067111

§ 371 Date: Dec. 27, 2023

(30) Foreign Application Priority Data
Jun. 28, 2021 (DE) 20 2021 103 431.9

(51) Int. Cl. G01M 11/02

(52) U.S. Cl. CPC G01M 11/0292

(57) ABSTRACT

A device for imaging through an optical system to be tested. The device comprises a first device section with a first degree of transmission for electromagnetic waves and a second device section with a second degree of transmission for the electromagnetic waves, wherein the second degree of transmission is greater than the first degree of transmission. At least one of the device sections has an annular shape.

The invention relates to a device for imaging by an optical system to be tested, and a test system and a method for testing an optical system.

In order to measure an imaging quality of an optical system on the basis of a modulation transfer function, an object can, for example, be imaged onto a sensor via the optical system to be tested, and a calculation of the modulation transfer function can be made on the basis of an intensity distribution received by the sensor. A two-dimensional measurement of the modulation transfer function, which is performed due to a focus shape that is often not rotationally symmetrical and with a conventional test structure being used, can however usually be accompanied by increased sensor noise. Conventional test structures include, for example, a so-called slit reticule or a slit-shaped test structure, a so-called cross reticule or a cruciform test structure, a so-called pinhole reticule or a punctiform test structure, or a so-called H reticule or an H-shaped test structure.

Against this background, the approach presented here presents an improved device for imaging by an optical system to be tested, an improved test system for testing an optical system, and an improved method for testing an optical system and also a use of such a device for testing an optical system according to the main claims. Advantageous embodiments and developments of the invention result from the following dependent claims.

According to embodiments, a device for imaging by an optical system to be tested or, in other words, a test structure for measuring an imaging quality of an optical system, can in particular be provided with the aid of a modulation transmission function, contrast transmission function, or modulation transfer function (MTF). The device or test structure can have a geometrically annular design. The device can enable a two-dimensional, direction-dependent measurement of the MTF within the image plane with a simultaneously high illumination of a sensor for image capture.

A two-dimensional MTF measurement can thus in particular advantageously be made possible by a device or test structure proposed herein due to its geometrically annular design. A light transmission, analogously to a cross reticule or a cruciform test structure, can also be achieved, for example. In particular, advantages of conventional test structures can thus be combined in a novel manner and previous disadvantages can be overcome. A further advantage of an annular test structure can consist in particular in that, in addition to a two-dimensional MTF measurement, a measurement of the effective focal length (EFL) is also made possible.

A device for imaging by an optical system to be tested is presented, wherein the device has the following features:
a first device section having a first degree of transmission for electromagnetic waves; and
a second device section having a second degree of transmission for the electromagnetic waves, wherein the second degree of transmission is greater than the first degree of transmission,
wherein one of the device sections has an annular shape.

The optical system can comprise at least one lens or another optical element. The device can be formed as a plate, disk or the like. The device can have a rectangular circumferential contour or a curved circumferential contour. The device can also be referred to as an annular test structure, as a ring reticule or a grid reticule with an annular structure. The electromagnetic waves can be light visible spectrum or other electromagnetic radiation.

According to an exemplary embodiment, the second device section can be annular. In this case, the second device section can be arranged between a first subsection and a second subsection of the first device section. In other words, the second device section can be embedded between the first subsection and the second subsection of the first device section. For example, the first subsection of the first device section can optionally additionally be annular and surround the second device section. The second subsection of the first device section can be circular and be surrounded by the second device section.

According to another embodiment, the first device section can be annular. In this case, the first device section can be arranged between a first subsection and a second subsection of the second device section. In other words, the first device section can be embedded between the first subsection and the second subsection of the second device section. For example, the first subsection of the second device section can optionally additionally be annular and surround the first device section. The second subsection of the second device section can be circular and be surrounded by the first device section.

In particular, an annular one of the device sections can be formed as a slit or annular gap. For example, the second device section can be formed as a slit or annular gap.

A test system for testing an optical system is also presented, wherein the test system has the following features:
an embodiment of a device presented herein; and
an evaluation device which is designed to evaluate an image of the device generated by the optical system to be tested in order to determine an evaluation result for testing the optical system.

In conjunction with the test system, an embodiment of the device presented herein can advantageously be introduced or used in order to test the optical system. In this case, the optical system can generate an image of the device which can be evaluated by means of the evaluation device of the test system.

The evaluation device can also be designed to determine a two-dimensionally measured modulation transfer function of the optical system as the evaluation result by using the image of the device generated by the optical system to be tested. In this case, the evaluation device can be designed to determine the evaluation result by using a Fourier transform.

Furthermore, the evaluation device can be designed to determine an effective focal length, and additionally or alternatively a direction-dependent magnification capability of the optical system as the evaluation result, by using the image of the device generated by the optical system to be tested. Using the device, the evaluation device can be designed to carry out a focal length measurement for different orientations and thus to determine additional optical variables such as distortion or anamorphic images, wherein even an orientation, for example, of the distortion can be determined.

A method for testing an optical system is also presented, wherein the method can be carried out using an embodiment of a test system mentioned herein, wherein the method comprises the following steps:
generating an image of the device by means of the optical system to be tested; and
evaluating the image of the device in order to determine an evaluation result for the testing of the optical system.

The method for testing can be carried out using and/or in conjunction with an embodiment of a test system mentioned herein. The step of evaluation can be carried out by an evaluation device of the test system. The evaluation result can have or represent at least one parameter for an imaging quality of the optical system.

According to an exemplary embodiment, in the evaluation step, by using the image of the device, a two-dimensionally measured modulation transfer function of the optical system can be determined as the evaluation result. A precise and informative test of the optical system can thus be carried out.

Here, in the evaluation step, the two-dimensionally measured modulation transfer function can be determined from a point spread function of the optical system, in particular by means of a Fourier transform. Here, the point spread function can be determined mathematically from a plurality of line spread functions of the optical system obtained in different cross-sectional planes.

In the evaluation step, an effective focal length and additionally or alternatively a direction-dependent magnification capability of the optical system can also be determined as the evaluation result by using the image of the device. Furthermore, an energy on a circular or square surface can be determined as the evaluation result. The evaluation result can be determined on the basis of the two-dimensionally measured modulation transfer function or the point spread function. A focal length measurement can thus be carried out for different orientations, and additional optical variables such as distortion or anamorphic images can be determined, wherein even an orientation, for example, of the distortion can be determined.

It is also advantageous to use an embodiment of a device mentioned herein for testing an optical system.

One exemplary embodiment of the invention is shown purely schematically in the drawings and is described in more detail below. In the figures:

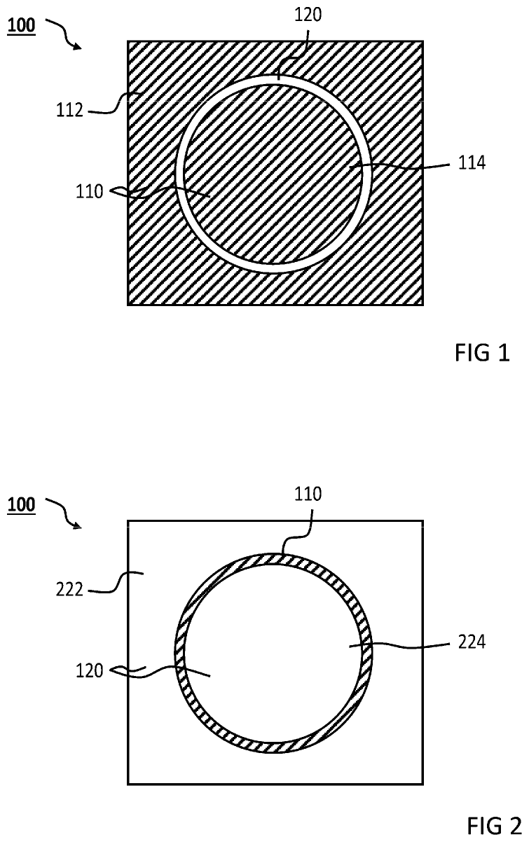

FIG. 1 shows a schematic representation of an exemplary embodiment of a device for imaging by an optical system to be tested,

FIG. 2 shows a schematic representation of an exemplary embodiment of a device for imaging by an optical system to be tested,

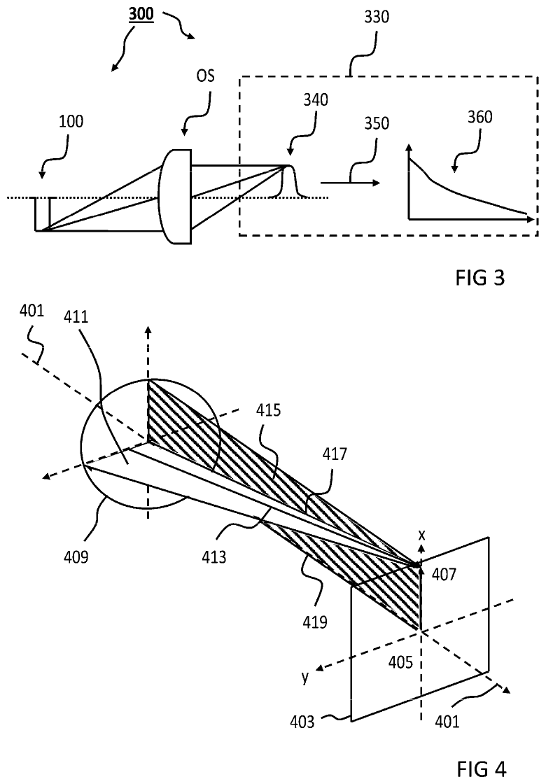

FIG. 3 shows a schematic representation of an exemplary embodiment of a test system for testing an optical system;

FIG. 4 shows a schematic representation of planes in an optical system;

FIG. 5 shows a schematic representation of an exemplary embodiment of a test system for testing an optical system; and

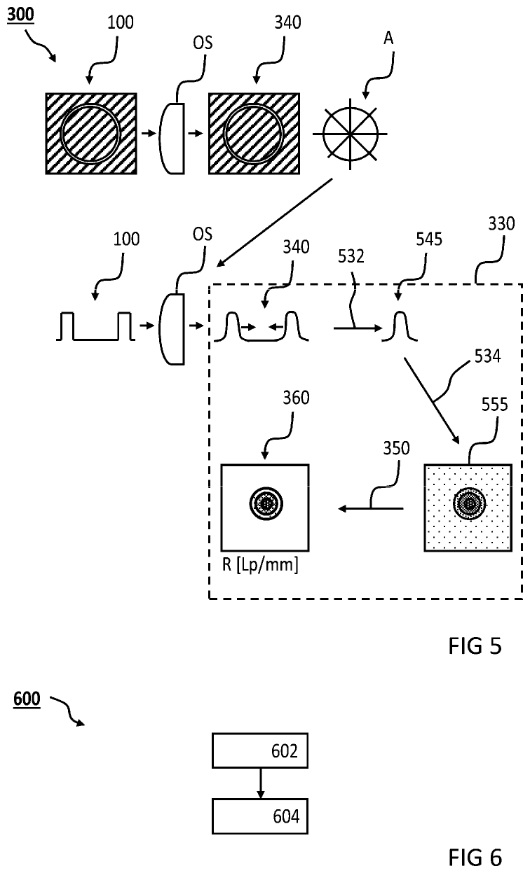

FIG. 6 shows a flowchart of an exemplary embodiment of a method for testing an optical system.

In the following description of advantageous exemplary embodiments of the present invention, the same or similar reference numerals are used for the elements that are shown in various figures and act similarly, whereby a repeated description of these elements is dispensed with.

FIG. 1 shows a schematic representation of an exemplary embodiment of a device 100 for imaging by an optical system to be tested. The device 100 is designed as an annular test structure, as a ring reticule or as a grid reticule with an annular structure. The device 100 or test structure comprises a first device section 110 having a first degree of transmission for electromagnetic waves and a second device section 120 having a second degree of transmission for the electromagnetic waves. The second degree of transmission is greater than the first degree of transmission. The second device section 120 thus has a greater degree of transmission than the first device section 110. At least one of the device sections 110, 120 has an annular shape. In particular, an annularly shaped one of the device sections 110, 120 takes the form of a slit or annular gap.

According to the exemplary embodiment shown in FIG. 1, the second device section 120 has an annular shape. The second device section 120 is arranged or embedded between a first subsection 112 and a second subsection 114 of the first device section 110. In other words, the first device section 110 is divided by the second device section 120 into the first subsection 112 and the second subsection 114.

FIG. 2 shows a schematic representation of an exemplary embodiment of a device 100 for imaging by an optical system to be tested. The device in FIG. 2 corresponds to the device in FIG. 1, except that, according to the exemplary embodiment shown in FIG. 2, the first device section 110 has an annular shape. The first device section 110 is arranged between a first subsection 222 and a second subsection 224 of the second device section 120.

FIG. 3 shows a schematic representation of an exemplary embodiment of a test system 300 for testing an optical system OS. The optical system OS is illustrated in the representation merely by way of example by a lens. The test system 300 comprises a device 100 for imaging by the optical system OS to be tested and an evaluation device 330. The device 100 corresponds to or resembles the device in one of the figures described above. The evaluation device 330 is designed to evaluate an image 340 of the device 100 generated by the optical system to be tested in order to determine an evaluation result 360 for the testing of the optical system OS. For this purpose, the evaluation device 330 can comprise an optical sensor or an interface to an optical sensor for capturing the image 340 and at least one determination unit.

According to an exemplary embodiment, the evaluation device 330 is designed to determine a two-dimensionally measured modulation transfer function of the optical system as the evaluation result 360 by using the image 340 of the device 100 generated by the optical system OS to be tested. The evaluation result 360 is determined from the image 340, for example by means of a Fourier transform 350. Optionally additionally, the evaluation device 330 is designed to determine an effective focal length and/or a direction-dependent magnification capability of the optical system OS as the evaluation result 360, by using the image 340 of the device 100 generated by the optical system OS to be tested.

FIG. 4 shows a schematic representation of planes in an optical system. The optical system corresponds to or resembles the optical system mentioned with reference to one of the figures described above. Shown are an optical axis 401, an image plane 403 defined by two axes x and y and having an axis point 405 and a field point 407, an exit pupil 409 of the optical system or of a lens, a sagittal plane 411 with a sagittal beam 413 extending along the same, a tangential plane 415 or meridional plane, a main beam 417, and an axis beam 419.

FIG. 5 is a schematic representation of an exemplary embodiment of a test system 300 for testing an optical system OS. The test system 300 corresponds to or resembles the test system in FIG. 3. The test system 300 comprises the device 100 to be imaged by the optical system OS to be tested and the evaluation device 330. The evaluation device 330 is designed to evaluate the image 340 of the device 100 generated by the optical system to be tested in order to determine an evaluation result 360 for the testing of the optical system OS.

In the representation, the device 100 is illustrated not only merely by way of example as the device from FIG. 1 but also in the form of its object contrast. The image 340 of the device 100 is illustrated in the representation not only as an image of the device 100 but also in the form of its image contrast, which image contrast is shown by two individual line spread functions. The optical system OS is illustrated in the representation merely by way of example by a lens between the device 100 and the image 340, thus also between the object contrast and the image contrast. In the representation in FIG. 5, an exemplary cross-sectional plane A for radial sections through the device 100 is also shown. This results in the object contrast and the image contrast corresponding to a radial section for such a cross-sectional plane A.

According to the exemplary embodiment shown here, the evaluation device 330 is designed to determine a two-dimensionally measured modulation transfer function of the optical system as the evaluation result 360 by using the image 340 of the device 100 generated by the optical system OS to be tested. Here the modulation transfer function indicates which contrast (or which modulation) can be transmitted by the optical system (OS) as a function of the spatial frequency R, represented in line pairs per millimeter (lp/mm). The evaluation device 330 is designed to determine the two-dimensionally measured modulation transfer function, i.e., here the evaluation result 360, from a point spread function 555 of the optical system OS, in particular by means of a Fourier transform 350. Here the evaluation device 330 is designed to mathematically determine the point spread function 555 from a plurality of line spread functions 545 of the optical system OS obtained in different cross-sectional planes A. For this purpose, the evaluation device in a first 330 is designed to superimpose the individual line spread functions of a radial section in a first superposition 532 or averaging to a superimposed line spread function 545 and to repeat this with multiple radial sections for at least one further cross-sectional plane A in order to generate the point spread function 555 by a second superposition 534 or averaging.

FIG. 6 shows a flowchart of an exemplary embodiment of a method 600 for testing an optical system. The method 600 for testing can be carried out in conjunction with and/or using the test system in one of the figures described above or a similar test system. The method 600 for testing comprises a generation step 602 and an evaluation step 604. In the generation step 602, an image of the device is generated by means of the optical system to be tested. In the evaluation step 604, the image of the device is evaluated in order to determine an evaluation result for the testing of the optical system.

Exemplary embodiments and basic principles and advantages of exemplary embodiments are summarized again below and explained in other words and/or briefly presented.

In particular, a device 100 designed as an annular test structure for direction-dependent MTF measurement is presented for imaging by an optical system OS to be tested. In particular, the device 100 is designed as a test structure for imaging by an optical system OS to be tested for the purpose of measuring the modulation transfer function (MTF) and/or the effective focal length and/or the direction-dependent magnification capability of the optical system OS. The test structure or device 100 comprises a region with high light transmission, the second device section 120, and a region with low light transmission, the first device section 110, wherein one of the regions has a geometrically annular structure. Furthermore, a test system 300 for testing an optical system OS is presented. Using the test system 300 and in particular the evaluation device 330, a method for ascertaining the effective focal length and/or the direction-dependent magnification or the direction-dependent MTF of the optical system OS by using the test structure or device 100, wherein an image 340 of the test structure or device 100 generated by the optical system OS to be tested is evaluated.

The basics of a measurement or determination of an imaging quality of an optical system OS with the aid of the MTF are explained below. The basic measurement method can also be represented schematically by means of FIG. 3. In this case, an object, here the test structure or device 100, is imaged onto a sensor via the optical system OS to be tested, and the MTF is calculated from the intensity distribution or image 340 received by the sensor. So that the MTF can be determined over a large range of spatial frequencies, it is recommended to use a narrow gap as object, such as the annular gap of the device 100. An image of a straight line provides, for example, an intensity distribution which is for obvious reasons referred to as a line spread function (LSF). By means of the Fourier transform, the MTF of the test object is finally obtained from the LSF. Due to the fact that the focus shape of an optical system OS is often not rotationally symmetrical, it is advantageous to measure the imaging performance in multiple orientations. According to exemplary embodiments, this can be made possible easily and in any number of orientations. However, a conventional procedure consists in orienting two directions corresponding to the sagittal plane 411 and the tangential plane 415, as shown in FIG. 4. The simplest variant for this would be the use of a cross as the test object. However, in contrast to the device 100, when a slit or cross is used as the test object, the MTF can be measured exclusively one-dimensionally perpendicular to the corresponding gap. An imaging performance in other orientations thus cannot be determined. For a two-dimensional MTF measurement in which any direction can be included, a punctiform test structure (pinhole reticule) is conventionally used. An intensity distribution in the imaging of such a punctiform test structure is referred to as a point response, point image function, point distribution function, or point spread function (PSF). In the case of a punctiform test structure, in contrast to the device 100, a quantity of light impinging on the sensor can be small, whereby noise of the sensor can be amplified as a possible source of error. An enlargement of a punctiform test structure would, for example, lead to a reduction in the spatial frequencies that can be used in the measurement.

An advantage of using the device 100 or annular test structure according to exemplary embodiments is that, in addition to a two-dimensional MTF measurement, a measurement of the effective focal length (EFL) is also made possible. Conventionally, a modified cross reticule would be used for this purpose. An example would be the use of an H reticule. The focal length can be deduced from the line spacing in the image via the magnification. However, a focal length measurement for different orientations can also be carried out with the test structure or device 100, and additional optical variables such as distortion or anamorphic images can thus be determined. An advantage of this is that the orientation, for example of the distortion, can also be determined.

The method 600 for testing can also be considered as a method for determining a parameter for the imaging quality of an optical system OS by using the image 340 or device of the test structure 100. A variant of such an evaluation method is the calculation of a point spread function 555 or point image function (PSF) from the image 340 of the test structure or device 100. In other words, according to exemplary embodiments, a use of the ring reticule or an operating mode of the device 100 is envisaged for determining a point spread function 555 or point image function (PSF), with the aid of which imaging parameters of an optical system OS can be determined.

FIG. 5 schematically shows how a point spread function 555 (PSF) is determined with the aid of the image 340 of the ring reticule or of the device 100, from which point spread function, for example, a two-dimensional MTF is determined as evaluation result 360. As can be seen in FIG. 5, the optical system 100 to be tested, which is shown in simplified form as a single lens, generates a blurred image of the ring structure as image 340. In an arbitrary cross-sectional plane A of the ring structure not only the object contrast but also the image contrast generated by the image can be seen. The image contrast has a blurring caused by the lens, which is represented by the rounded edges in the intensity distribution. Due to the image of a ring structure, i.e., of the device 100, the intensity distribution in a cross-sectional plane A, for example the sagittal plane, has two separate line image functions (LSF), which for the sake of simplicity are referred to as left-hand or right-hand LSF. A resulting LSF 545 is now calculated mathematically from the two individual line image functions, e.g. by forming an average value. By repeating this process for a plurality of cross-sectional planes A through the ring structure, multiple superposed LSFs 545 are determined, which in turn are combined to form a PSF 555, which describes the two-dimensional intensity distribution of a point in the image plane. Since strictly speaking it is not a measured but a calculated PSF 555, this can also be referred to as a “pseudo”-PSF. From this pseudo-PSF or point spread function 555, the two-dimensional MTF of the optical system OS that is to be measured or tested is determined in a known manner, in this case, for example, using a Fourier transform 350. Further imaging parameters of the optical system OS can also be determined using the PSF 555, such as, for example, the energy on a circular or square surface that is also referred to as encircled or ensquared energy.

The use of the ring structure or device 100 offers the advantage. in particular as against the use of a pinhole, that a large number of pixels in the sensor plane are illuminated, whereby disruptive moiré effects can be compensated for. In addition, when the ring reticule or the device 100 is used, a greater quantity of light is available than when a conventional pinhole is used. A further advantage of the ring structure or device 100 is that the magnification factor of the optics to be measured or of the optical system OS to be tested can be easily determined.

If an exemplary embodiment comprises an “and/or” conjunction between a first feature and a second feature, this is to be read in such a way that the exemplary embodiment has both the first feature and the second feature according to one embodiment, and either only the first feature or only the second feature according to a further embodiment.

1. Device for imaging by an optical system to be tested, the device comprising:
a first device section having a first degree of transmission for electromagnetic waves; and
a second device section having a second degree of transmission for the electromagnetic waves, wherein the second degree of transmission is greater than the first degree of transmission,
wherein at least one of the device sections has an annular shape.

2. Device according to claim 1, wherein the second device section has an annular shape, wherein the second device section is arranged between a first subsection and a second subsection of the first device section.

3. Device according to claim 1, wherein the first device section has an annular shape, wherein the first device section is arranged between a first subsection and a second subsection of the second device section.

4. Device according to claim 1, wherein an annularly shaped one of the device sections takes the form a slit or annular gap.

5. Test system for testing an optical system, the test system comprising:
a device according to claim 1; and
an evaluation device which is designed to evaluate an image of the device generated by the optical system to be tested in order to determine an evaluation result for the testing of the optical system.

6. Test system according to claim 5, wherein the evaluation device is designed to determine a two-dimensionally measured modulation transfer function of the optical system as the evaluation result by using the image of the device generated by the optical system to be tested.

7. Test system (300) according claim 5, wherein the evaluation device is designed to determine an effective focal length and/or a direction-dependent magnification capability of the optical system as the evaluation result, by using the image of the device generated by the optical system to be tested.

8. Method for testing an optical system, wherein the method can be carried out using a test system according to claim 5, wherein the method comprises the following steps:
generating an image of the device by means of the optical system to be tested; and
evaluating the image of the device in order to determine an evaluation result for the testing of the optical system.

9. Method according to claim 8, wherein in the evaluation step, by using the image of the device, a two-dimensionally measured modulation transfer function of the optical system is determined as the evaluation result.

10. Method according to claim 9, wherein, in the evaluation step, the two-dimensionally measured modulation transfer function is determined from a point spread function of the optical system, in particular by means of a Fourier transform, wherein the point spread function is mathematically determined from a plurality of line spread functions of the optical system obtained in different cross-sectional planes.

11. Method according to claim 8, wherein in the evaluation step, by using the image of the device, an effective focal length and/or a direction-dependent magnification capability of the optical system is determined as the evaluation result.

12. Use of a device according to claim 1 for testing an optical system.
